(19) United States
(12) Patent Application Publication
(10) Pub. No.: US 2013/0325551 A1
(43) Pub. Date: Dec. 5, 2013

(54) SYSTEM AND METHOD FOR MODELING DEMAND AND OPTIMIZING PRICES WITH IMMUNITY TO OUT-OF-STOCK EVENTS

(71) Applicant: Clear Demand, Inc., Scottsdale, AZ (US)

(72) Inventor: Adam N. Rosenberg, Scottsdale, AZ (US)

(21) Appl. No.: 13/911,021

(22) Filed: Jun. 5, 2013

Related U.S. Application Data
(60) Provisional application No. 61/689,376, filed on Jun. 5, 2012.
(60) Provisional application No. 61/689,361, filed on Jun. 5, 2012.

(51) Int. Cl. G06Q 30/02

(52) U.S. Cl. CPC G06Q 30/0202
USPC 705/7.31

(57) ABSTRACT

The disclosed technology improves the process of generating recommended prices for retail products. First, the present technology makes it possible to model shopper demand when sales data includes time periods with zero unit sales without hypothesizing whether the time periods are out-of-stock events or zero sales. This can be accomplished by applying a truncated Poisson distribution and the Newton-Raphson method to the non-zero unit sales to generate a coefficient vector that maximizes the likelihood of the observations in the sales data. Second, the present technology can be used to generate recommended prices for a group of products that optimize revenue and profit while limiting the number of products that require price changes to a predefined threshold value. This can be accomplished by iteratively replacing a current best value solution with a next best value solution across a collection of product networks until an acceptable number of unchanged prices is achieved.

### CROSS REFERENCE TO RELATED APPLICATIONS

This application claims the benefit of: U.S. Provisional Patent Application 61/689,376, entitled PROVISIONAL PATENT—SYSTEM AND METHOD FOR MODELING DEMAND AND OPTIMIZING PRICES WITH IMMUNITY TO OUT-OF-STOCK EVENT, filed Jun. 5, 2012, and U.S. Provisional Patent Application 61/689,361, entitled PROVISIONAL PATENT—OPTIMIZING REVENUE AND PROFIT WITH LIMITED NUMBER OF PRICE CHANGES, filed Jun. 5, 2012.

### FIELD OF INVENTION

The present disclosure pertains to demand modeling, and more specifically pertains to demand modeling when sales data includes time periods with zero unit sales.

### BACKGROUND

There has been a steady evolution in retail science towards solutions with more sensitivity to business reality. Early mathematical solutions in price optimization made retailers more revenue and profit but often stretched operating rules to or past their limits. In particular, retailers are often reluctant to change too many prices in a single wave of optimization. For example, a store may limit the number of products that have price changes. One solution to this problem is for retailers to set a number of price changes that can be made in a single wave. The retailer ranks individual products in order of price-change benefit and changes the price on the products that provide the best price-change benefit. One problem associated with such a price-change scheme is that the price changes may violate one or more business rules. When attempting to follow multiple business rules, the calculations can become difficult and often not followed.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for demand modeling and price optimization techniques that can be used in generating recommended prices for retail products. First, the present technology makes it possible to model shopper demand when sales data includes time periods with zero unit sales without hypothesizing whether the time periods are out-of-stock events or zero sales. Second, the present technology can be used to generate recommended prices for a group of products that optimize revenue and profit while limiting the number of products that require price changes to a predefined threshold value.

Demand modeling is a key step in the process of generating recommended prices. Shopper demand can be modeled as a function of price, promotional status, time of year, day of week, seasonality, holidays, trends, and/or external factors, such as traffic or weather. Point-of-sale data is a reliable indicator of quantity and price when some positive quantity is sold. However, a difficulty often faced in demand modeling is that sales history data can include one or more time periods in which the sales data reflects zero unit sales. During these periods it is not known whether a zero unit sales period represents an out-of-stock event or zero sales. The present technology addresses this limitation by generating a demand model only considering time periods with positive unit sales. That is, the demand modeling technique can derive maximum-likelihood functions that ignore zero unit sales events, thereby eliminating the need to predict out-of-stock events.

The disclosed demand modeling technique generates a demand model by first applying a truncated Poisson distribution to the non-zero unit sales in the sales data to generate a derivative vector D and a Hessian matrix H. Then the present demand modeling technique applies a Newton-Raphson method using the derivative vector D and the Hessian matrix H to generate a coefficient vector V. The coefficient vector V can include the coefficients qₖ and β for the product store combinations that maximize the likelihood of the observations in the sale history data. These two steps can be performed iteratively until the change in the coefficient vector between rounds is sufficiently small. The generated demand model can then used for price optimization, promotion optimization, markdown optimization, assortment optimization, shelf-space optimization, and/or retail replenishment.

Price optimization is another key step in the process of generating recommended prices. Using a demand model, such as one generated using the presently disclosed demand modeling technique, prices can be optimized within each network based on a previously chosen tradeoff of revenue, profit, and various business constraints. The result is a set of recommended prices in which one or more products can be assigned a price different than an original price of the product. One problem store owners can face is how to change prices. For example, store owners can have a limit on how may prices can be changed due to limited personnel. Therefore, store owners would like to make the price changes that provide the greatest price-change benefit. Determining which products to make price changes on becomes more difficult with each business rule that needs to be followed. The present price optimization technique addresses this limitation by constraining the number of price changes while still optimizing for revenue and profit. That is, the price optimization technique can generate recommended price sets that optimize revenue and profit with a limited number of price changes.

The disclosed price optimization technique can be applied to a collection of product networks to generate a set of recommended prices for the collection by first selecting a best value solution based on monetary value from a price optimization solution set for each product network. Each best value solution has an associated number of unchanged prices. Using the associated unchanged price numbers, the technique calculates a total number of unchanged prices. The technique compares the total number of unchanged prices to a predefined target number of unchanged prices. If the total number of unchanged prices is less than the predefined target number of unchanged prices (i.e., there are too many price changes), the technique iteratively replaces a best value solution with a next best value solution until the total number of unchanged prices is greater than or equal to the predefined target number of unchanged prices.

The technique can replace a current best value solution with a next best value solution by calculating a best price-change ratio for the pre-computed price-optimized solutions for each product network. The price-change ratio being a difference in monetary value between the current best value solution and another price-optimized solution in the price-optimized solution set divided by a denominator. The denominator being either (1) a target number of unchanged prices which is the predefined target number of unchanged prices less a current total number of unchanged prices for the current selected best value solutions, or (2) the difference in the number of unchanged prices between the two price-optimized solutions, depending on whether the number of unchanged prices between the two price-optimized solutions is greater than the predefined target number. From these best price-change ratios, the technique can select an overall best price-change ratio across the collection of product networks.

The technique can then replace a current selected best value solution with the price-optimized solution corresponding to the overall best price-change ratio. The technique chooses for replacement a current selected best value solution that is associated with the same product network as the selected price-optimized solution. Using the selected price-price optimized solution (i.e., the next best value solution), the technique can update the current total number of unchanged prices based on the number of unchanged prices associated with the new set of current selected best value solutions.

Once the selected best value solutions are identified that satisfy the predefined target number of unchanged prices, the technique can output information about the selected best value solutions. In some cases, the output can be a point on a revenue-profit frontier.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIGS. 1A and 1B illustrate exemplary system embodiments;

FIG. 2 illustrates an exemplary method embodiment for retail price optimization;

FIG. 3 illustrates an exemplary method embodiment for demand modeling;

FIG. 4 illustrates an exemplary method embodiment for generating the product networks with price-optimized solution set(s);

FIG. 5 illustrates a scatter plot of an exemplary price-optimized solution set corresponding to a revenue-profit weight for a single product network;

FIG. 6 illustrates an exemplary method embodiment for generating recommended price sets for a collection of weights, such as revenue-profit weights;

FIG. 7 illustrates an exemplary price change management method embodiment for generating a recommended price set across a collection of networks for a selected weight or optimization factor;

FIG. 8 illustrates a collection of scatter plots of exemplary price-optimized solutions sets;

FIG. 9 illustrates an exemplary revenue-profit frontier curve for a sequence of revenue-profit weights;

FIG. 10, illustrates a scatter plot of an exemplary combination of price-optimized solution sets across a plurality of product networks;

FIG. 11 illustrates an exemplary method embodiment for replacing a current best value solution with a next best value solution; and

FIG. 12 illustrates an exemplary method embodiment for calculating a best price-change ratio for a price-optimized solution set.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

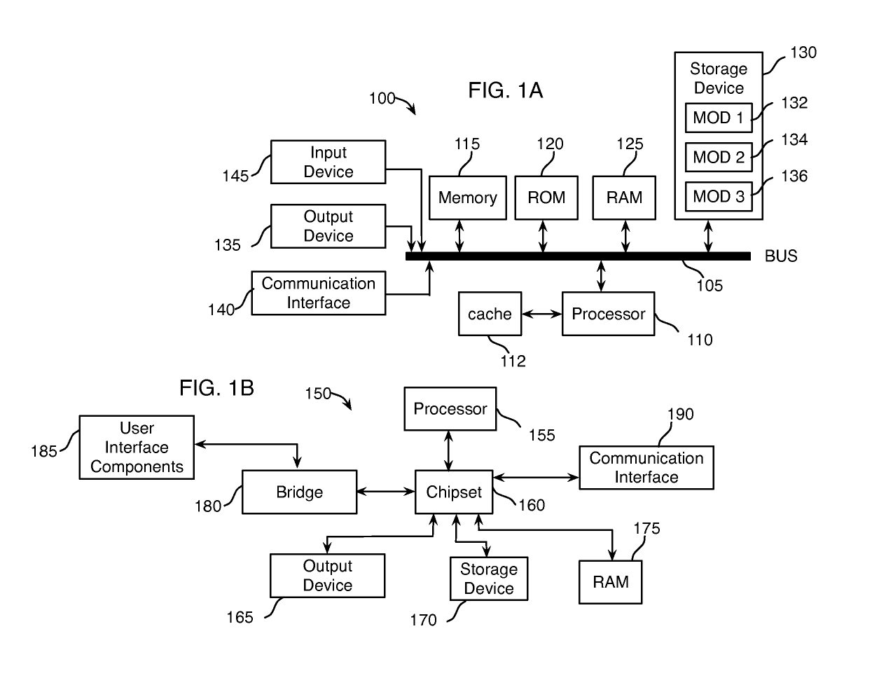

The present disclosure addresses the need in the art for an improved technique of generating recommended prices for retail products. Using the present technology it is possible to make improvements to two parts of the price generation process. First, the present technology makes it possible to model shopper demand when sales data includes time periods with zero unit sales without hypothesizing whether the time periods are out-of-stock events or zero sales. Second, the present technology can be used to generate recommended prices for a group of products that optimize revenue and profit while limiting the number of products that require price changes to a predefined threshold value. The disclosure first sets forth a discussion of a basic general purpose system or computing device in FIGS. 1A and 1B that can be employed to practice the concepts disclosed herein before turning to a discussion of relevant terms and a more detailed description of the improved techniques for generating recommended prices.

FIG. 1A and FIG. 1B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 1A illustrates a conventional system bus computing system architecture 100 wherein the components of the system are in electrical communication with each other using a bus 105. Exemplary system 100 includes a processing unit (CPU or processor) 110 and a system bus 105 that couples various system components including the system memory 115, such as read only memory (ROM) 120 and random access memory (RAM) 125, to the processor 110. The system 100 can include a cache of high-speed memory connected directly with, in close proximity to, or integrated as part of the processor 110. The system 100 can copy data from the memory 115 and/or the storage device 130 to the cache 112 for quick access by the processor 110. In this way, the cache can provide a performance boost that avoids processor 110 delays while waiting for data. These and other modules can control or be configured to control the processor 110 to perform various actions. Other system memory 115 may be available for use as well. The memory 115 can include multiple different types of memory with different performance characteristics. The processor 110 can include any general purpose processor and a hardware module or software module, such as module 1 132, module 2 134, and module 3 136 stored in storage device 130, configured to control the processor 110 as well as a special-purpose processor where software instructions are incorporated into the actual processor design. The processor 110 may essentially be a completely self-contained computing system, containing multiple cores or processors, a bus, memory controller, cache, etc. A multi-core processor may be symmetric or asymmetric.

To enable user interaction with the computing device 100, an input device 145 can represent any number of input mechanisms, such as a microphone for speech, a touch-sensitive screen for gesture or graphical input, keyboard, mouse, motion input, speech and so forth. An output device 135 can also be one or more of a number of output mechanisms known to those of skill in the art. In some instances, multimodal systems can enable a user to provide multiple types of input to communicate with the computing device 100. The communications interface 140 can generally govern and manage the user input and system output. There is no restriction on operating on any particular hardware arrangement and therefore the basic features here may easily be substituted for improved hardware or firmware arrangements as they are developed.

Storage device 130 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 125, read only memory (ROM) 120, and hybrids thereof.

The storage device 130 can include software modules 132, 134, 136 for controlling the processor 110. Other hardware or software modules are contemplated. The storage device 130 can be connected to the system bus 105. In one aspect, a hardware module that performs a particular function can include the software component stored in a computer-readable medium in connection with the necessary hardware components, such as the processor 110, bus 105, display 135, and so forth, to carry out the function.

FIG. 1B illustrates a computer system 150 having a chipset architecture that can be used in executing the described method and generating and displaying a graphical user interface (GUI). Computer system 150 is an example of computer hardware, software, and firmware that can be used to implement the disclosed technology. System 150 can include a processor 155, representative of any number of physically and/or logically distinct resources capable of executing software, firmware, and hardware configured to perform identified computations. Processor 155 can communicate with a chipset 160 that can control input to and output from processor 155. In this example, chipset 160 outputs information to output 165, such as a display, and can read and write information to storage device 170, which can include magnetic media, and solid state media, for example. Chipset 160 can also read data from and write data to RAM 175. A bridge 180 for interfacing with a variety of user interface components 185 can be provided for interfacing with chipset 160. Such user interface components 185 can include a keyboard, a microphone, touch detection and processing circuitry, a pointing device, such as a mouse, and so on. In general, inputs to system 150 can come from any of a variety of sources, machine generated and/or human generated.

Chipset 160 can also interface with one or more communication interfaces 190 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 155 analyzing data stored in storage 170 or 175. Further, the machine can receive inputs from a user via user interface components 185 and execute appropriate functions, such as browsing functions by interpreting these inputs using processor 155.

It can be appreciated that exemplary systems 100 and 150 can have more than one processor 110 or be part of a group or cluster of computing devices networked together to provide greater processing capability.

Having disclosed some components of a computing system, the disclosure now turns to a brief description of terms relevant to retail science.

Product Grouping: distinct products are items on retail shelves or online perceived as different by shoppers. The products can be grouped into different types of groupings. The process of identifying price families and product networks is called product linking.

Price Families: products can be grouped into price families. Each price family can have products which share similar shopper demand and require identical prices. For example, six-ounce (6 oz.) containers of Dannon™ Yogurt in various flavors, such as, plain, vanilla, strawberry and strawberry-banana, would be in one price family since they share similar shopper demand and are priced the same.

Product Networks: price families can be grouped into product networks. Each product network can have price families that are linked together by at least one comparative business rule. For, example, Coke™ products of different sizes, Pepsi™ products of different sizes, and store-brand soda products of different sizes can be linked together by one or more comparative rules. For example, a twelve ounce (12 oz.) can of Coke™ and a twelve ounce (12 oz.) can of Pepsi™ may be the same price and each may be twenty percent (20%) more expensive than a twelve ounce (12 oz.) can of the store brand cola soda. Similarly, a sixteen ounce (16 oz.) container of Coke™ may be ten percent (10%) more expensive than a twelve ounce (12 oz.) can of Coke™. In another example, a sixteen ounce (16 oz.) container of Pepsi™ may be thirty percent (30%) more expensive than a twelve ounce (12 oz.) of the store brand cola soda.

Store Grouping: stores are different places to shop. An online retail environment can be considered to be one store. The process of identifying markets, zones, locations, and areas is called store linking. Markets can be a collection stores with common shoppers, typically defined geographically, but can be defined demographically. Zones can be collections of markets defined by retailers for one or more reasons. Locations can be collections of one or more stores defined by the granularity of sales history. Areas can be collections of one or more locations defined by the granularity of price decisions. While retail-science can have areas as disjoint collections of locations, an area for a product can be different for two products. For example, a first soda retailer can have city-by-city pricing for their sodas and a second soda retailer can have state wide pricing.

Customer Types: communities of shoppers identified in a pricing environment. For example, a product might be offered at a discount for a group of people, such as club members, people over a specific age and students.

Sales Types: can be different types of selling promotions which can include no promotions, signage, products at the end of an aisle (“endcaps”), discount and buy some, get some free.

Decision Prices: individual price decisions can be based on price family, area, customer type and sales type.

Decision Price Sets: decision prices can be grouped into decision price sets based on one or more comparative business rules, such as size or brand.

Bounded Business Rules: can be ranges imposed on individual decision prices. Examples can include competitive prices (price of a product based on competitor's price), margin requirements (no less than cost plus a set percentage), price-change amounts (no change more than a set percentage or amount or no change less than a set percentage or amount) and locked decision price (price cannot change from its current price). Retailers can also have bounded business rules with lower bounds based on competition and upper bounds based on margin.

Comparative Business Rules: can be relationships between two decision prices. For example, a size rule where the price for one product having a first size can have a fixed rate higher than the same product having a second size, such as a twenty ounce (20 oz.) bag of chips can cost 1.6 times higher than a ten ounce (10 oz.) bag of chips). In another example, a brand rule where one brand of a product can have a fixed rate higher than a second brand of the same product, such as the price for a national brand soda can be 1.3 times higher than a store brand soda can. Decision prices can be bounded by two comparative business rule, such as brand and size.

Maximum Price Change: price changes for a product can only be changed by a certain percentage or amount from a set price, such as the manufactured recommended price.

Minimum Price Change: price changes for a product can only be changed by a certain percentage or amount from a set price, such as the manufactured recommended price.

Margin: the price for a product required to earn a minimum margin. Margin can be profit divided by revenue or price minus cost divided by price.

Locked Prices: a price which cannot be changed.

Competitive Pricing: a price can be required to be lower than the same or a similar product offered by another retailer.

Size: two products that are the same, but different sizes, can have a price relationship. Typically, the larger sized product is more expensive than the smaller sized product, but is less expensive on a unit basis. For example, a twenty ounce (20 oz.) container for a first product would have a fixed price relationship with a ten ounce (10 oz.) container for the first product, such as 1.5 or 1.8 times more expensive.

Brand: two products that are similar but different brands can have a price relationship. Typically, one brand is considered superior to the other and there is a range of price ratios based on shopper perception. For example, a brand name cereal would be between 1.3 and 1.6 times as expensive as the store-brand version. When different brand products are different sizes, the constraint can be considered a brand constraint and the ratios combine in the least-restrictive way. For example, a twenty ounce (20 oz.) box a name brand cereal should be between (1.3×1.5) and (1.8×1.6) as expensive as a ten ounce (10 oz.) box of the store-brand version.

Product Line: two products that are the same brand, but different in another way, can have a price relationship. Typically, the same company or brand can offer different products under the same name/brand with a fixed price relationship. For example, a dairy company can offer a twenty ounce (20 oz.) container of ice cream to have a fixed price relationship with a twenty ounce (20 oz.) container of frozen yogurt, such as 1.2 or 1.3 times more expensive.

Cannibalization (Substitution): occurs when the sales of a first product detract from the sales of a second product. For example, when Coke™ goes on sale, its increased sales decrease the sales of Pepsi™.

Affinity (Halo Affect): occurs when the sales of one product enhance the sales of another product. For example, when the sales of hot dogs lead to increased sales of buns, relish, charcoal, etc.

Promotion: products on sale, or offered to specific customer groups, must be offered at a lower price compared to the recommended price. For example, the lower price can be for ten percent (10%) off or buy one get one free (BOGO).

Ending Numbers: product prices can be required to end in appropriate values. Typically, prices end with a nine (9) as the last digit in the price, such as “79” or “99.” In one or more cases, the last two digits of the price can indicate the status of the product. For example, a product that ends in “99” can be for products that are always sold by the store, a product that ends in “89” can be for products that are seasonal, and a product that ends in “79” can be for products that will no longer be carried once they are sold out.

Multiples: products that come in multiples can have different pricing rules than single-item prices that end with a “9” for the last digit for the price. For example, when multiples of a product are offered, the price can end with two zeros (“00”), such as three (3) for three dollars ($3.00) or five (5) for five dollars ($5.00).

Number of Price Changes: a global rule for an assignment of decision prices may involve a limit on the number or percentage of prices that can change. For example, no more than twenty percent (20%) of the prices can change from current to recommended prices.

Global Margin: a global rule for the entire collection of decision prices can be expected global margin, which is that total profit (price minus cost) divided by total price should be above a specified value.

Revenue-Profit Weight: defines a business preference for profit over revenue. A value of zero for the revenue-profit weight means a retailer is aiming for maximum revenue in price assignment. A value of one for the revenue-profit weight means a retailer is aiming for maximum profit in price assignment. A value w between the two means a retailer is aiming to maximize (1−w)R+wP, where R is revenue and P is profit.

Sales History Data: each entry in the sales history can specify a product or price family, a location, a customer type, a sales type, a time period, and/or numerical data such as price, costs, and/or units sold. Time periods can typically be in weeks with date ranges. Due to the nature of point of sales (POS) systems, the sales history typically does not contain zero sales information. It only contains data when a positive quantity is sold. Sales history can be for one or more groupings of products, all products offered for sale, or a subset of the products offered for sale. Sales history can cover one or more locations, all locations, or a subset of locations selling the products. Time periods can be coincident, overlapping, or non-overlapping for different groupings of products and locations.

Having defined a glossary of relevant terms, the disclosure now turns to a brief introductory description of using retail price optimization to generate recommended prices for retail products. In retail price optimization, a system can use demand modeling to analyze sales history data to generate a demand model, or demand-model parameters, of consumer demand for products. The system can then use the model to compute prices that maximize revenue, profit, or a combination of revenue and profit.

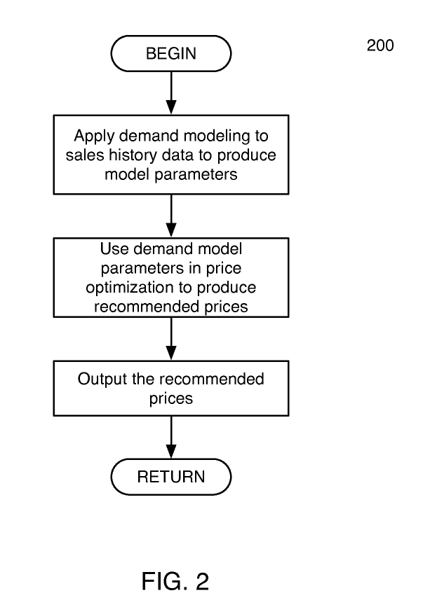

FIG. 2 is a flowchart illustrating an exemplary retail price optimization method 200. For the sake of clarity, this method is discussed in terms of an exemplary computing system, such as is shown in FIGS. 1A and 1B. Although specific steps are shown in FIG. 2, in other embodiments a method can have more or less steps than shown.

The retail price optimization begins when the computing system applies demand modeling to sales history data to produce model parameters (202), which can be used in a variety of retail-science analyses, including forecasting sales, price optimization, markdown, assortment planning, inventory replenishment, promotion planning, etc. In some embodiments, the predictions can be by product, store, time, and promotion status. The sales data can specify a variety of information about one or more products over a sequence of time periods. For example, the sales data can specify the number of sales per week over a two year time period.

The demand model can be a publically known demand model or a proprietary demand model. The model parameters can include economic demand elasticity and baseline sales. The model parameters can also include factors for seasonality and/or for specific local, such as regional and national events and holidays. In one or more embodiments, one or more demand models can have specific multipliers to account for promotional or sales events. The sales data can be for a common duration, such as two months or two years.

After applying demand modeling to sales data to produce demand-model parameters (or a demand model), the computing system can use the demand-model parameters in price optimization to produce recommended prices (204). The recommended prices can be for the decision prices corresponding to the sales history data. In some embodiments, the price optimization can be applied to the model parameters and other inputs. The other inputs can include one or more of current prices, bounded business rules, and/or comparative business rules. The recommended prices can be a single list of prices or list of prices for one or more revenue-profit weights. As a result, the recommended prices can indicate revenue-profit goals, ending-number price compliance, common prices for price families, compliance with bounded business rules, compliance with comparative business rules, global margin requirements, and/or price-change requirements. In one or more embodiments, the computing system can forecast unit sales from current prices and recommended prices using the demand-model parameters. The computing system can also use the demand-model parameters for markdown analysis, assortment planning, inventory replenishment, promotion planning, etc.

After using the model parameters and other inputs in price optimization to produce recommended prices, the computing system can output the recommended prices (206). In some embodiments, the computing system can output the forecast unit sales from current prices and recommended prices. The output can be in one or more forms, including, but not limited to, rendering the recommended prices on a display, printed, and stored in one or more databases communicatively coupled to the processor. The recommended prices can be one set of decision-price recommendations or representing several revenue-profit weights.

As described above, demand modeling is a key step in the process of generating recommended prices. Shopper demand can be modeled as a function of price, promotional status, time of year, day of week, seasonality, holidays, trends, and/or external factors, such as traffic or weather. In some cases, shopper demand elasticity (percent decrease in unit sales per percent increase in price) can be modeled as a linear in price, thus yielding a negative-exponential demand model: F=e^{q}^{₀}^{-βP}, where F is the forecast unit sales and P is the price. In the demand model, q₀ can represent scale of quantity, the log of how many people would buy “for free,” and β can represent the elasticity factor in proportion to price.

Multiple products with common demand elasticity can be aggregated into a price family. Likewise, multiple stores with common demand elasticity can be aggregated into a zone. For a collection of products in the price family and stores in the zone, the demand model becomes F_{K}=e^{q}^{ₖ}^{-βP}, where qₖ can represent the specific quantity factor for a product-store combination K. By applying the demand model to the sales data, a computing system can generate coefficients qₖ and β where F_{K} best fits the observed sales data for each collection of products and stores.

Point-of-sale data is a reliable indicator of quantity and price when some positive quantity is sold. However, a difficulty often faced in demand modeling is that sales history data can include one or more time periods in which the sales data reflects zero unit sales. During these periods it is not known whether a zero unit sales period represents an out-of-stock event or zero sales. The traditional method of handling incomplete sales data has been to use observed sales data when unit sales are positive and apply heuristics to determine which of the remaining time periods are out of stock events and which are zero sales. Using the traditional method, when a time period has zero sales, the price that was offered has to be estimated since it is not observed in the sales data.

The present demand modeling technique addresses this limitation by generating a demand model only considering time periods with positive unit sales. That is, the demand modeling technique can derive maximum-likelihood functions that ignore zero unit sales events, thereby eliminating the need to predict out-of-stock events. In general, the present demand modeling technique generates a demand model by first applying a truncated Poisson distribution to the non-zero unit sales in the sales data to generate a derivative vector D and a Hessian matrix H. Then the present demand modeling technique applies a Newton-Raphson method using the derivative vector D and the Hessian matrix H to generate a coefficient vector V. The coefficient vector V can include the coefficients qₖ and β for the product store combinations that maximize the likelihood of the observations in the sale history data.

Let U_{KT} be the units sold for price-store combination K in time period T at the price P_{KT}. Then unit sales can be approximated as a Poisson distribution with mean:

F_{KT}=e^{q}^{ₖ}^{-βP}^{_{KT}},

and a probability of N unit sales:

$$Prob ( N ) = \frac{{e}^{- F} {F}^{N}}{N !} .$$

However, since the demand modeling technique only considers time periods with positive unit sales, a conditional probability term is introduced to the Poisson distribution:

$$Prob ( N \vert N > 0 ) = \frac{{e}^{- F} {F}^{N}}{N ! ( 1 - {e}^{- F} )} ,$$

thereby creating a truncated Poisson distribution.

Based on the truncated Poisson distribution, the likelihood of unit sales U_{KT} for price-store combination K in time period T at the price P_{KT} is:

$$Prob ( {U}_{KT} ) = \frac{{{e}^{- {F}_{KT}} ( {F}_{KT} )}^{{U}_{KT}}}{{U}_{KT} ! ( 1 - {e}^{- {F}_{KT}} )} .$$

Additionally, the total, combined likelihood L of the entire sales history of all the products and stores in the price family and zone is:

$$L = {\prod }_{KT} \frac{{{e}^{- {F}_{KT}} ( {F}_{KT} )}^{{U}_{KT}}}{{U}_{KT} ! ( 1 - {e}^{- {F}_{KT}} )} .$$

Maximizing the likelihood can be accomplished by maximizing the natural logarithm of the likelihood:

$$= log L = {\sum }_{KT} - {F}_{KT} + {U}_{KT} ( {q}_{k} - β {P}_{KT} ) - log {U}_{KT} ! - log ( 1 - {e}^{- {F}_{KT}} ) .$$

The maximum of L occurs when its derivative is zero:

$$\begin{matrix}\begin{matrix} \frac{\partial }{\partial β} = {\sum }_{KT} {P}_{KT} {F}_{KT} - {P}_{KT} {U}_{KT} - \frac{\partial B}{\partial β} \\ = {\sum }_{KT} {P}_{KT} {F}_{KT} - {P}_{KT} {U}_{KT} - \frac{\partial {B}_{KT}}{\partial {A}_{KT}} \frac{\partial {A}_{KT}}{\partial {F}_{KT}} \frac{\partial {F}_{KT}}{\partial β} \\ = {\sum }_{KT} {P}_{KT} {F}_{KT} - {P}_{KT} {U}_{KT} - ( - {C}_{KT} ) ( - {A}_{KT} ) ( - {P}_{KT} ) ( - {F}_{KT} ) \\ = {\sum }_{KT} {P}_{KT} {F}_{KT} - {P}_{KT} {U}_{KT} - {P}_{KT} {E}_{KT}\end{matrix} & ( 1 ) \\ \begin{matrix} \frac{\partial }{\partial {q}_{K}} = {\sum }_{T} - {F}_{KT} + {U}_{KT} - \frac{\partial B}{\partial {q}_{K}} \\ = {\sum }_{T} - {F}_{KT} + {U}_{KT} - \frac{\partial {B}_{KT}}{\partial {A}_{KT}} \frac{\partial {A}_{KT}}{\partial {F}_{KT}} \frac{\partial {F}_{KT}}{\partial {q}_{K}} \\ = {\sum }_{T} - {F}_{KT} + {U}_{KT} - ( - {C}_{KT} ) ( - {A}_{KT} ) ( {F}_{KT} ) \\ = {\sum }_{KT} - {F}_{KT} + {U}_{KT} - {E}_{KT}\end{matrix} \\ where \\ {A}_{KT} = {e}^{- {F}_{KT}} , {B}_{KT} = log ( 1 - {A}_{KT} ) , {C}_{KT} = \frac{1}{1 - {A}_{KT}} , and {E}_{KT} = {C}_{KT} {A}_{KT} {F}_{KT} \\ \frac{\partial {A}_{KT}}{\partial {F}_{KT}} = - {e}^{- {F}_{KT}} = - {A}_{KT} , \frac{\partial {B}_{KT}}{\partial {A}_{KT}} = \frac{- 1}{1 - {A}_{KT}} = - {C}_{KT} , and \frac{\partial {C}_{KT}}{\partial {A}_{KT}} = \frac{1}{{( 1 - {A}_{KT} )}^{2}} = {( {C}_{KT} )}^{2} & ( 2 )\end{matrix}$$

Since there is only one maximum, and the derivative is zero only once, it suffices to find parameters q_{K} and β satisfying equations (1) and (2). Thus, derivative vector D=0 where,

$$V = ( \begin{matrix}β \\ {q}_{K}\end{matrix} ) and D = D ( V ) = ( \begin{matrix}\frac{\partial }{\partial β} \\ \frac{\partial }{\partial {q}_{K}}\end{matrix} ) ,$$

with one dimension for each product-store combination K. This occurs when L reaches its zenith.

Using the derivative vector D, the demand modeling technique can define the Hessian matrix H:

$$H = \frac{d D}{d V} = ( \begin{matrix}\frac{{\partial }^{2} }{\partial {β}^{2}} & \frac{{\partial }^{2} }{\partial β \partial {q}_{K}} \\ \frac{{\partial }^{2} }{\partial {q}_{k} \partial β} & \frac{{\partial }^{2} }{\partial {q}_{K}^{2}}\end{matrix} )$$

$$with$$

$${H}_{ββ} = \frac{{\partial }^{2} }{\partial {β}^{2}} = {\sum }_{KT} - {P}_{KT}^{2} {F}_{KT} - {P}_{KT}^{2} {G}_{KT} {F}_{KT}$$

$${H}_{β {q}_{K}} = {H}_{{q}_{K} β} = \frac{{\partial }^{2} }{\partial β \partial {q}_{KT}} = \frac{{\partial }^{2} }{\partial {q}_{KT} \partial β} = {\sum }_{T} - {P}_{KT} {F}_{KT} - {P}_{KT} {G}_{KT} {F}_{KT}$$

$${H}_{{q}_{K} {q}_{K}} = \frac{{\partial }^{2} }{\partial {q}_{KT}^{2}} = {\sum }_{T} - {F}_{KT} - {G}_{KT} {F}_{KT}$$

$$where$$

$$\begin{matrix}{G}_{KT} = \frac{\partial {E}_{KT}}{\partial {F}_{KT}} \\ = \frac{\partial {C}_{KT}}{\partial {F}_{KT}} {A}_{KT} {F}_{KT} + {C}_{KT} \frac{\partial {A}_{KT}}{\partial {F}_{KT}} {F}_{KT} + {C}_{KT} {A}_{KT} \frac{\partial {F}_{KT}}{\partial {F}_{KT}} \\ = \frac{\partial {C}_{KT}}{\partial {A}_{KT}} \frac{\partial {A}_{KT}}{\partial {F}_{KT}} {A}_{KT} {F}_{KT} + {C}_{KT} \frac{\partial {A}_{KT}}{\partial {F}_{KT}} {F}_{KT} + {C}_{KT} {A}_{KT} \frac{\partial {F}_{KT}}{\partial {F}_{KT}} \\ = - {C}_{KT}^{2} {A}_{KT}^{2} {F}_{KT} - {C}_{KT} {A}_{KT} {F}_{KT} + {C}_{KT} {A}_{KT}\end{matrix}$$

The non-β, (q_{J},qₖ)_{J≠K}, off-diagonal elements of H are zero.

After generating the derivative vector D and the Hessian matrix H, the demand modeling technique can use the Newton-Raphson method to iteratively solve for D=0. That is, for each iteration, the demand modeling technique can compute:

Vᵢ₊₁=Vᵢ−H⁻¹D.

After the last iteration, the coefficient vector V contains the model coefficients for elasticity and quantity factors for product-store combinations that maximize the likelihood of the observations in the sales history data. Additionally, while the demand modeling technique is illustrated using model coefficients for elasticity and quantity factors for product-store combinations, the model coefficients can be any observed parameters, such as price, promotional status, seasonality, holidays, trends, and/or external factors, e.g. traffic or weather.

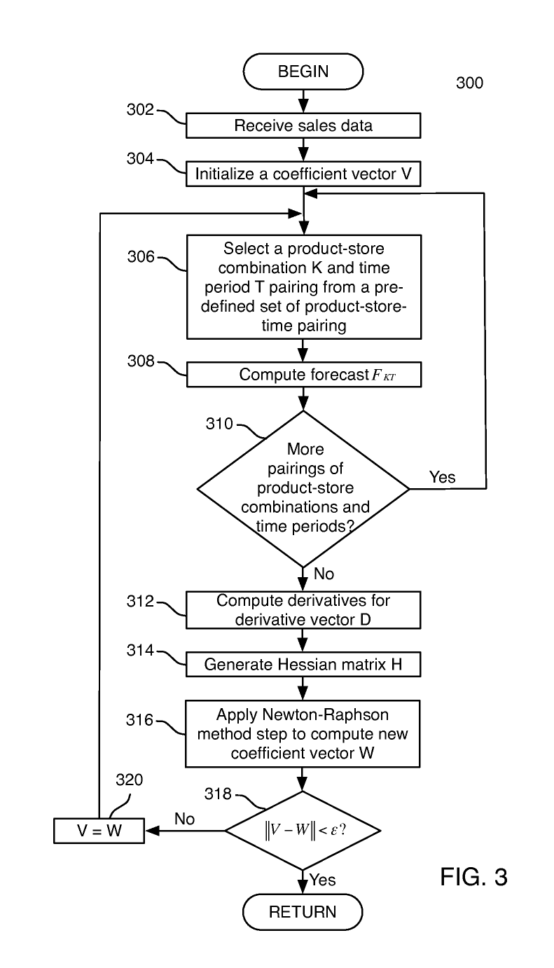

FIG. 3 is a flowchart illustrating an exemplary demand modeling method 300. For the sake of clarity, this method is discussed in terms of an exemplary computing system, such as is shown in FIGS. 1A and 1B. Although specific steps are shown in FIG. 3, in other embodiments a method can have more or less steps than shown.

The demand modeling begins when the computing system receives sales history data for at least one product, in at least one store, for a set of time periods (302). The sales data can include at least one time period in which the unit sales for a product are zero. The zero unit sales could represent an out-of-stock event or zero sales. In some cases, the sales data can include inventory data, which can be used to determine whether a time period with zero unit sales is an out-of-stock event or actual zero unit sales.

After receiving the sales data, the computing system can generate the demand model by first initializing a coefficient vector V (304). The coefficient vector V can include coefficient vectors for an observable parameter, such as elasticity β and quantity factors for product-store combinations. A product-store combination K can be a collection of products in a price family and a set of stores in a zone. In some embodiments, to initialize the coefficient vector V, the computing system can reverse engineer coefficients for elasticity β and quantity factors for product-store combinations based on sales history data weighted against an assumption that average prices chosen in the sales history data are optimal for demand.

Once the computing system has initialized the coefficient vector V, the computing system can iteratively update the coefficient vector by performing a number of rounds of (1) applying the truncated Poisson distribution, and (2) applying a step in the Newton-Raphson method. The number of rounds is dynamically determined based on a change in the coefficient vector V during the round. That is, for each product-store combination K and time period T represented in the sales data with positive unit sales, the computing system selects the product-store combination K and time period T pairing from a predefined set of product-store-time pairings (306). For that pairing, the computing system computes the forecast (308):

F_{KT}=e^{q}^{ₖ}^{-βP}^{_{KT}}.

After computing the forecast F_{KT}, the computing system checks if there are additional pairings of product-store combinations and time periods (310). If so, the computing system repeats the steps of selecting a product-store combination K and time period T (306), computing the forecast F_{KT} (308). If no additional pairings remain, the computing system the computed forecasts to compute the derivative D_{β} for elasticity and a derivative D_{q}_{_{K}} for each product-store combination K (312) for the derivative vector D:

$${D}_{β} = {\sum }_{KT} {P}_{KT} {F}_{KT} - {P}_{KT} {U}_{KT} - {P}_{KT} {E}_{KT}$$

$${D}_{{q}_{K}} = {\sum }_{KT} - {F}_{KT} + {U}_{KT} - {E}_{KT}$$

The computing system also generates the Hessian matrix H (314), as described above.

Using the derivative vector D and the Hessian matrix H, the computing system applies a step of the Newton-Raphson method to compute a new coefficient vector W (316), such that

W=V=H⁻¹D.

After computing the new coefficient vector W, the computing system tests the change in coefficients from V to W by comparing their difference to a predefined threshold value ε (318). If the difference is still too large, the computing system copies the coefficient vector W into the coefficient vector V (320), and returns to step 306 to complete another iteration. However, if ∥V−W∥<ε, then the coefficient vector V contains the model coefficients for elasticity and quantity factors for product-store combinations that maximize the likelihood of the observations in the sales history data. The generated demand model can then used for price optimization, promotion optimization, markdown optimization, assortment optimization, shelf-space optimization, and/or retail replenishment.

As described above, price optimization is another key step in the process of generating recommended prices. Using a demand model, such as that generated above, prices can be optimized within each network based on a previously chosen tradeoff of revenue, profit, and various business constraints. The result is a set of recommended prices in which one or more products can be assigned a price different than an original price of the product. In theory, such an approach produces an ideal set of prices that maximize revenue and/or profit. However, the set of recommended prices may be unworkable in a realistic business setting.

One problem store owners can face is how to change prices. For example, store owners can have a limit on how may prices can be changed due to limited personnel. Therefore, store owners would like to make the price changes that provide the greatest price-change benefit. Determining which products to make price changes on becomes more difficult with each business rule that needs to be followed. For example, price relationships between different sizes of the same product and different, interchangeable brands can make it difficult to optimize revenue and profit while keeping price changes down to the required levels. The present price optimization technique addresses this limitation by constraining the number of price changes while still optimizing for revenue and profit. That is, the price optimization technique can generate recommended price sets that optimize revenue and profit with a limited number of price changes.

The price optimization technique can be applied to networks of rule-related product prices and mathematical tradeoffs of value for price changes. In general, the present price optimization technique generates a set of recommended prices for a collection of product networks by first selecting a best value solution from a price optimization solution set for each product network. Each best value solution has an associated number of unchanged prices. Using the associated unchanged price numbers, the technique calculates a total number of unchanged prices. The technique compares the total number of unchanged prices to a predefined target number of unchanged prices. If the total number of unchanged prices is less than the predefined target number of unchanged prices (i.e., there are too many price changes), the technique iteratively replaces a best value solution with a next best value solution until the total number of unchanged prices is greater than or equal to the predefined target number of unchanged prices.

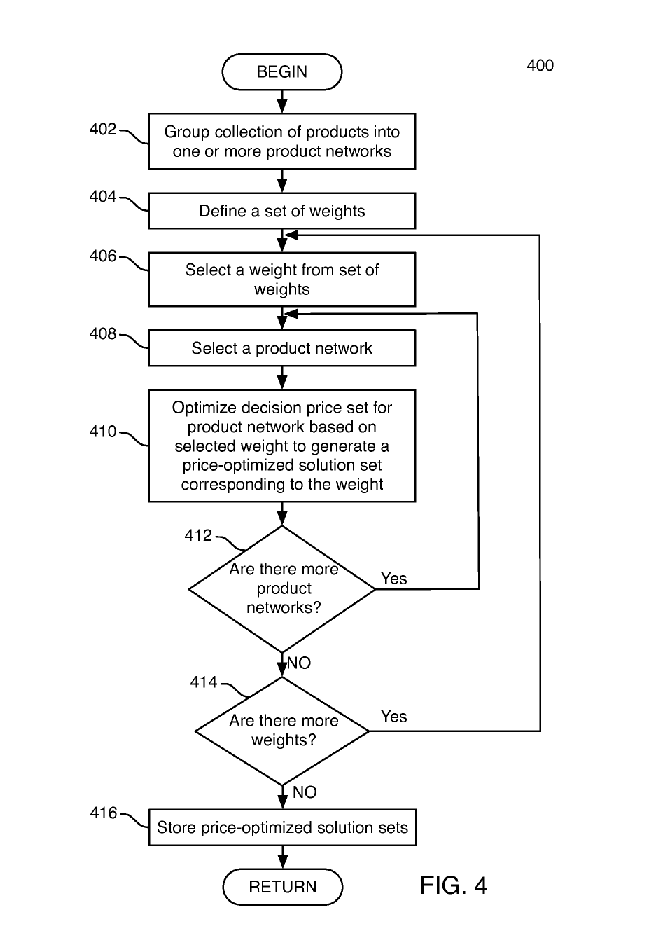

The price optimization technique operates on a collection of product networks where each product network has at least one price-optimized solution set. FIG. 4 is a flowchart illustrating an exemplary method 400 for generating the product networks with price-optimized solution set(s). For the sake of clarity, this method is discussed in terms of an exemplary computing system, such as is shown in FIGS. 1A and 1B. Although specific steps are shown in FIG. 4, in other embodiments a method can have more or less steps.

Method 400 begins when the computing system groups a collection of products into one or more product networks (402). The computing system can first group the products into product families. After identifying product families, the computing system can group the product families into product networks by applying one or more business rules, such as size or brand relationships. For example, products with prices related by business rules, such as size, quantity, or brand, can be grouped into the same product network. Each product network can have a decision price set, which can be defined by applying comparative business rules to decision prices for the price families in the product network.

The computing system can also define one or more price-optimizations, such as a revenue-profit optimization. The computing system can apply the one or more price-optimizations to generate a plurality of price-optimized solution sets for each product network by optimization the decision price set for each product network. In some cases, the one or more price-optimizations can be applied independently such that a first price-optimization generates a first plurality of price-optimized solution sets and a second price-optimization generates a second plurality of price-optimized solution sets. The one- or more price-optimizations can also be applied in conjunction with each other. For example, a first price-optimization can generate a plurality of price-optimized solution sets. Then a second price-optimization can be applied to each of those price-optimized solution sets. Additionally, in some cases, a price-optimization can define a set of weights or optimization factors. These weights or factors can be used to generate multiple price-optimization solution sets from a single decision price set. One possible price-optimization is a revenue-profit optimization. The revenue-profit optimization can define a set of revenue-profit weights.

The computing system can also define a set of weights (404), such as revenue-profit weights. For example, a revenue-profit weight scheme can be defined with a range of zero to one using 0.02 increments. In this case, the scheme would define a set of 51 revenue-profit weights.

The computing system can then generate one or more price-optimized solution sets for each product network by first selecting a weight from the set of weights (406). Then the computing system can select a product network from the one or more product networks (408), and optimize the decision set for the product network based on the selected weight to generate a price-optimized solution set corresponding to the weight (410). After generating the price-optimized solution set for a (product network, weight) pair, the computing system can check if there are more product networks (412). If so, the computing system repeats the steps of selecting a product network (408) and optimizing the decision set to generate a price-optimized solution set (410). If all of the product networks have been processed, the computing system checks if there are more weights (414). If so, the computing system repeats the steps of selecting a weight (406), and generating a price-optimized solution set corresponding to the selected weight for each product network. If all of the weights have been processed, the computing system can store the collection of price-optimized solution sets (416). Continuing with the example revenue-profit weight scheme with 51 weights from above, performing method 400 would generate 51 price-optimized solution sets for each product network.

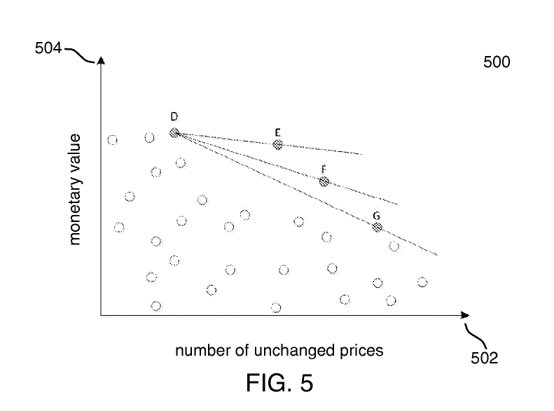

FIG. 5 illustrates a scatter plot 500 of an exemplary price-optimized solution set corresponding to a revenue-profit weight for a single product network. Each value in the price-optimized solution set has a monetary value and number of unchanged prices. A point in the price-optimized solution set corresponds to a no-change solution. That is, a solution where all products are left at their original prices. The monetary value can be defined for a weight W. For example, for a revenue-profit weight, monetary value can be defined as ((1−W)×Revenue)+(W×Profit). As shown, the scatter plot 500 has the number of unchanged prices on the abscissa (X) axis 502 and the monetary value on the ordinate (Y) axis 504. In this price-optimized solution set, point D has the highest monetary value.

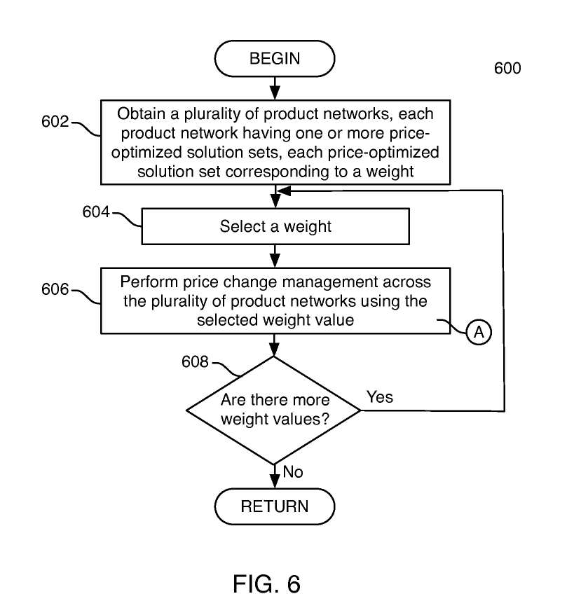

FIG. 6 is a flowchart illustrating an exemplary method 600 for generating recommended price sets for a collection of weights, such as revenue-profit weights. In particular, method 600 can be used to generate recommended price sets that optimize revenue and profit with a limited number of price changes. For the sake of clarity, this method is discussed in terms of an exemplary computing system, such as is shown in FIGS. 1A and 1B. Although specific steps are shown in FIG. 6, in other embodiments a method can have more or less steps.

Method 600 begins when the computing system obtains a collection of product networks (602). Each product network in the collection can have one or more price-optimized solution sets. The one or more price-optimized solution sets can be generated using a variety of techniques, including method 400 in FIG. 4. In some embodiments, the one or more price-optimized solution sets can be pre-computed and stored. Alternatively, the one or more price-optimized solution sets can be computed as part of method 600. For example, this could occur when method 600 is used to generate recommended price sets for a new or updated data set, or when the underlying demand model changes. Each price-optimized solution set can correspond with a weight or other optimization factor, such as a revenue-profit weight.

The computing system can then generate a recommended price set for each of one or more weights by iteratively applying a price change management optimization across the collection of obtained production networks. To do this, the computing system can select a weight or optimization factor (604), such as a revenue-profit weight. In some cases, the weight can be selected from a predefined set of weights. For example, a predefined weight scheme can be defined with a range of zero to one, using 0.02 increments. In this case, the scheme would define 51 weights, and thus the computing system would iterate 51 times producing a recommended price set for the collection of product networks for each of the 51 weights. For example, on the first iteration the computing system can select a weight of zero (0), then 0.02, then 0.04, until the final weight (e.g., 1.00) is selected. However, the weight for each iteration can also be determined dynamically based on at least one previously generated recommended price set. Additionally, the weight can be selected through a combination of predefined and dynamic selection. For example, a first and second weight can be predefined, while the n+2 weights can be selected dynamically.

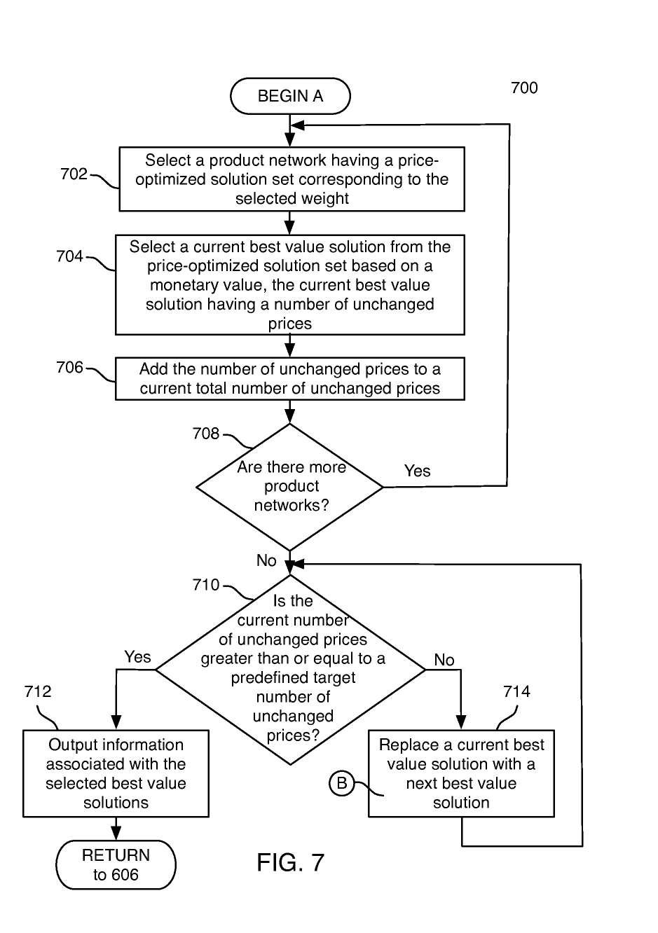

After selecting a weight, the computing system can perform the price change management optimization across the product networks using the selected weight (606). The price change management optimization can be performed using a variety of techniques including method 700 in FIG. 7, described below. After applying the price change management optimization for the selected weight, the computing system can check if there is a next weight (608). If so, the computing system repeats the steps of selecting a new weight (604) and performing the price change management optimization across the product networks using the new weight (606). If no weights remain, the computing system can resume previous processing, which can include repeating method 600. An advantage to the present price optimization technique, such as that in method 600, is that it enables the use of product networks optimized for a first revenue-profit weight to be used to manage price changes for a second revenue-profit weight, even when the first and second revenue-profit weights are different.

FIG. 7 is a flowchart illustrating an exemplary price change management method 700 for generating a recommended price set across a collection of networks for a selected weight or optimization factor. In particular, method 600 can be used to generate recommended price sets that optimize revenue and profit with a limited number of price changes. For the sake of clarity, this method is discussed in terms of an exemplary computing system, such as is shown in FIGS. 1A and 1B. Although specific steps are shown in FIG. 6, in other embodiments a method can have more or less steps.

Price change management method 700 can begin when the computing system selects a product network from the collection of product networks (702). The product network can have one or more price optimized solution sets. Of these, one price-optimized solution set corresponds to the weight or optimization factor selected for the current execution of the price change management optimization.

After selecting the product network, and thus the price-optimized solution set, the computing system can select a current best value solution from the price-optimized solution set based on monetary value (704). For example, the current best value solution for the price-optimized solution set in FIG. 5 would be point D. As previously, described, the selected current best value solution can have an associated number of unchanged prices. That is, for the selected best value solution, the number of products whose prices will need to be changed is known.

Once a current best value solution is selected, the computing system can add the associated number of unchanged prices to a current total number of unchanged prices (706). The current total tallies the number of unchanged prices across all product networks in the collection. After updating the current total number of unchanged prices, the computing system can check if there is another product network in the collection that still needs processing (708). If so, the computing system repeats the steps of selecting a new product network (702), selecting a current best value solution from the price-optimized solution set for the selected product network (704), and updating the current total number of unchanged prices (706). If all product networks in the collection have been processed, then the current total number of unchanged prices reflects the number of products across all product networks that would need to be changed for the current recommended price set. For example, if there are ten product networks, then the current total number of unchanged prices is the sum of the unchanged prices for the 10 selected current best value solutions.

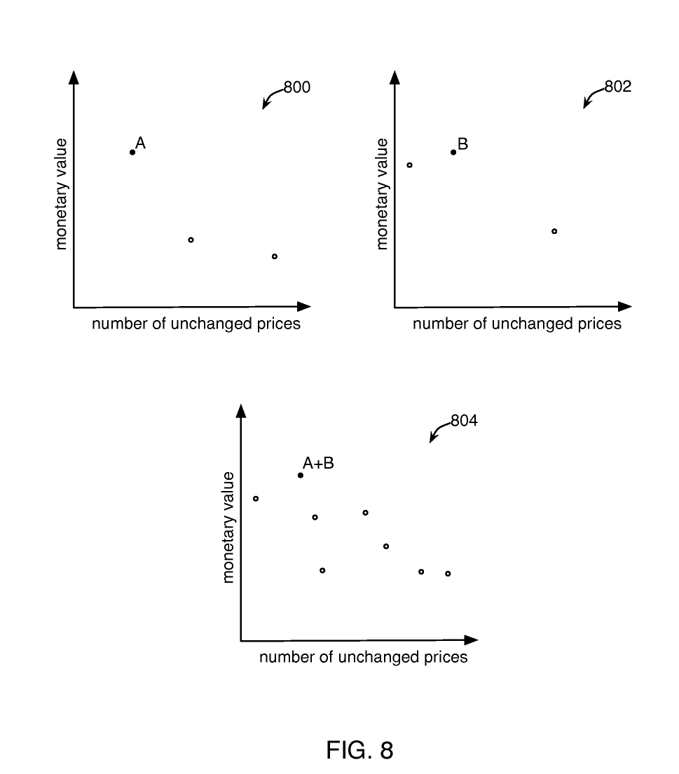

To illustrate the concept of combining best value solutions across product networks, consider graphs 800, 802, and 804 in FIG. 8. Scatter plot 800 represents a price-optimized solution set for a first product network. For the first product network, the best value solution based on monetary value is point A, and it has an associated first number of unchanged prices. Scatter plot 802 represents a price-optimized solution set for a second product network. For the second product network, the best value solution based on monetary value is point B, and it has an associated second number of unchanged prices. Scatter plot 804 represents the combination of the two price-optimized solution sets for the product networks in 802 and 804. Point A+B is the summation of the best value solutions from the first price-optimized solution set and the second price-optimized solution set. The other points in 804 represent the different combinations of summing a point from each price-optimized solution set. Thus, if there are n number of product networks with k solutions each, then there can be kⁿ number of possible combinations is the combined solution.

Returning to FIG. 7, after calculating the current total number of unchanged prices, the computing system can compare the calculated current total number of unchanged prices with a predefined target number of unchanged prices (710). The predefined target number of unchanged prices can reflect a retailer's price change threshold. That is, the number of price changes feasible for the retailer based on various constraints, such as personnel resources, cost of the actual change due to relabeling or updating a database, etc.

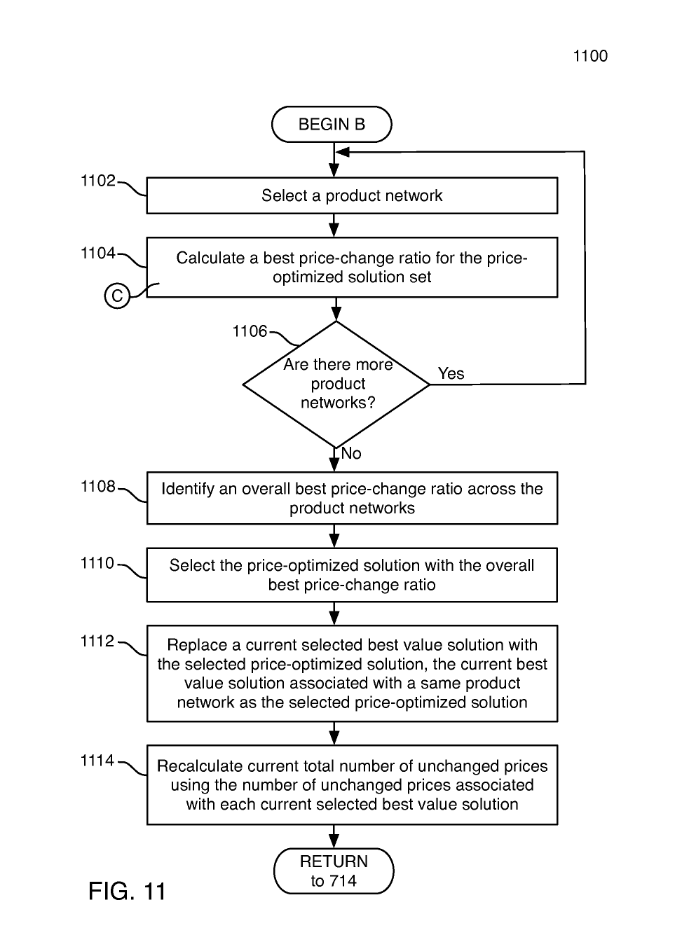

If the current total number of unchanged solutions is less than the predefined target number of unchanged solutions, the computing system can replace a current best value solution with a next best value solution (714). The best value solution replacement can be performed using a variety of techniques including method 1100 in FIG. 11, described below. After performing the replacement, the computing system can recheck the updated current number of unchanged values. This replacement and check loop can continue until a solution is found that satisfies the predefined target number of unchanged values. It should be noted that the loop will always end because a possible solution is the original solution where all prices are unchanged.

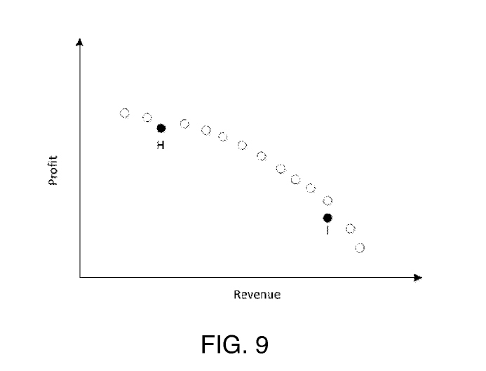

If the current total number of unchanged solutions is greater than or equal to the predefined target number of unchanged solutions, the computing system can output information associated with the selected best value solutions (712). The output can occur in one or more forms, including saving, rendering, and/or printing the information. The computing system can save a file comprising the information. The file can be saved in memory associated with the computing system, such as in a database communicatively coupled to a processor in the computing system. The computing system can render the information on a display communicatively to the computing system. The computer system can transmit the information to a printer communicatively coupled to the computing system. In some embodiments, the output can be a point on a revenue-profit frontier. That is, the computing system can calculate a total revenue and a total profit across the selected best value solutions, and plot a point corresponding to the total revenue and total profit. For example, FIG. 9 illustrates a revenue-profit frontier curve for a sequence of revenue-profit weights. After outputting information, computing system can resume previous processing, which can include resuming processing at step 606 of method 600 in FIG. 6.

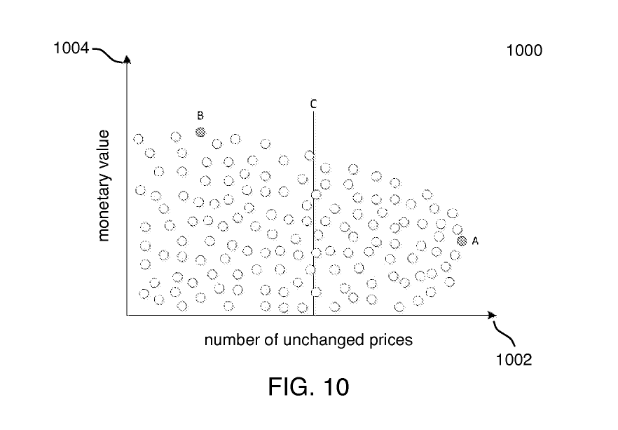

FIG. 10 illustrates a scatter plot 1000 of an exemplary combination of price-optimized solution sets across a plurality of product networks where each price-optimized solution set corresponds to a same revenue-profit weight. As shown, scatter plot 1000 has the number of unchanged prices on the abscissa (X) axis 1002 and the revenue-profit monetary value on the ordinate (Y) axis 1004. Each point in scatter plot 1000 represents a summation of a price value from each product network in the collection of product networks. Point A (the right-most point) represents the original input solution where none of the prices are changed across all of the product networks. Point B (the upper-most point) represents the highest value across all of the product networks. Point B is the summation of all of the best value solutions from each product network. The other points represent the different combinations of summing a point from each product network. Line C represents the number of unchanged prices that is permitted, e.g., the predefined target number of unchanged prices. To maximize revenue and profit, it is desirable to have the highest monetary value for a point that lies on line C, which means the maximum number of price changes has occurred. When point B lies to the right of line C, all of the price changes associated with point B can occur. However, when point B lies to the left of line C, there are too many prices changes, and there is a need to reduce the number of price changes, thereby increasing the number of unchanged prices.

As noted above, if there are n product networks with k solutions each, thus an exhaustive search of all the solutions would involve kⁿ computations. Because the computational cost of evaluating every solution is too high, a technique to identify a solution can be to give up the price changes that gain the least. The total data points in FIG. 10 are the sum of individual product network data points, such as those in FIG. 5, it is possible to find the convex hull of FIG. 10 by following solution-to-solution changes in the individual product networks. Thus, replacing a current best value solution with a next best value solution can be achieved by iteratively examining each network to find the cheapest reduction of price changes in terms of value per price not changed. For example, if point D in FIG. 5 has 18 prices not changed and point E has 25 prices not changed, then the value change from D to E should be divided by seven to get the value per price change. The product network with the best price change ratio is selected as the next best value solution, and is used to replace a current best value solution.

FIG. 11 is a flowchart illustrating an exemplary method 1100 for replacing a current best value solution with a next best value solution. For the sake of clarity, this method is discussed in terms of an exemplary computing system, such as is shown in FIGS. 1A and 1B. Although specific steps are shown in FIG. 11, in other embodiments a method can have more or less steps.

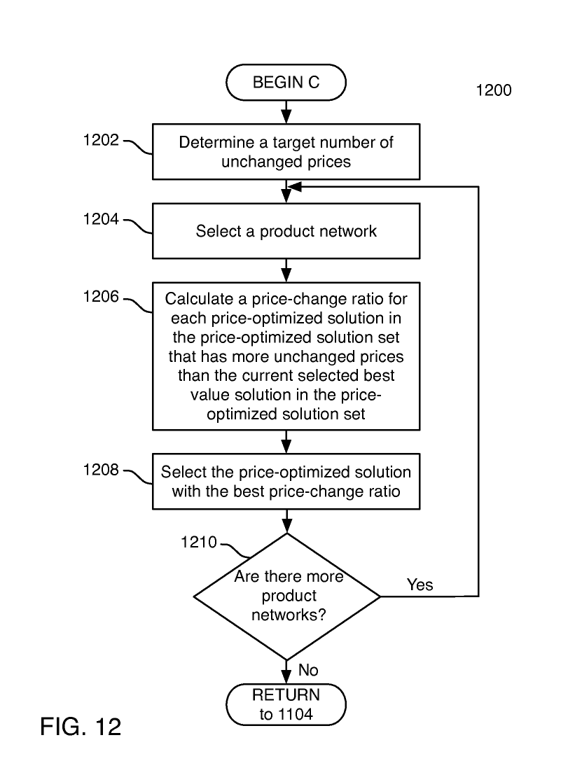

Method 1100 can begin when the computing system selects a product network from the collection of product networks (1102). The product network can have a price-optimized solution set. In some cases, the price-optimized solution set can be a pre-computed solution set. Using the price-optimized solution set, the computing system can calculate a best price-change ratio for the price-optimized solution set (1104). The calculating a best price-change ratio for a price-optimized solution set can be performed using a variety of techniques, including method 1200 in FIG. 12, described below. After calculating the best price-change ratio, the computing system can check if there is another product network in the collection that still needs processing (1106). If so, the computing system repeats the steps of selecting a new product network (1102) and calculating a best price-change ratio for the price-optimized solution set (1104).

If all product networks in the collection have been processed, then the computing system can identify an overall best price-change ratio across the product networks (1108). The computing system can use the identified best price-change ratio to select the corresponding price-optimized solution with the overall best price-change ratio (1110), which is a next best price-optimized solution.

After identifying the next best price-optimized solution, the computing system can replace a current selected best value solution with the selected next best price-optimized solution (1112). The computing system replaces the current selected best value solution that is associated with the same product network as the selected next best price-optimized solution. For example, referring to FIG. 5 again, if point D is a current selected best value solution, and point E is identified as the next best price-optimized solution, the computing system would replace point D with point E because point D and point E belong to the same price-optimized solution set and product network.

After replacing a current selected best value solution with a selected next best price-optimized solution, the computing system can recalculate the current total number of unchanged prices using the number of unchanged prices associated with each current selected best value solution (1114). This calculation is similar to the calculation done in steps 702, 704, and 706 in method 700 in FIG. 7, but now using the next best price-optimized solution for at least one of the product networks. After recalculating the current total number of unchanged prices, the computing system can resume previous processing, which can include resuming processing at step 714 of method 700 in FIG. 7.

FIG. 12 is a flowchart illustrating an exemplary method 1200 for calculating a best price-change ratio for a price-optimized solution set. For the sake of clarity, this method is discussed in terms of an exemplary computing system, such as is shown in FIGS. 1A and 1B. Although specific steps are shown in FIG. 12, in other embodiments a method can have more or less steps.

Method 1200 can begin when the computing system determines a target number of unchanged prices (1202). The target number of unchanged prices is the predefined target number of unchanged prices less a current total number of unchanged prices for the current selected best value solutions. The target number of unchanged prices is the number of unchanged prices that are needed to land on line C in FIG. 10. A rationale for using the computed target number of unchanged prices is that a solution that overshoots the predetermined target number of unchanged prices may not be the best choice in total value even when it presents the most-favorable ratio per price change.

After determining the target number of unchanged prices, the computing system can select a product network from the collection of product networks (1204). Then the computing system can calculate a price-change ratio for each price-optimized solution in the price-optimized solution set that has more unchanged prices than the current selected best value solution in the price-optimized solution set (1206). For example, in FIG. 5, if point D is the current select best value solution, the computing system can consider all points to the right of D, but not the points to the left of D.

The price-change ratio can be the difference in monetary value between the two price-optimized solutions divided by a denominator. The denominator can be the determined target number if the difference in number of unchanged prices between the two price-optimized solutions is greater than the determined target number. The denominator can be the difference in number of unchanged prices between the two price-optimized solutions if the difference is not greater than the determined target number. Once the computing system has calculated the price change ratios for the price-optimized solution set, the computing system can select the price-optimized solution with the best price-change ratio (1208).

After selecting the price-optimized solution with the best price-change ratio, the computing system can check if there is another product network, e.g., more price-optimized solution sets, in the collection that still needs processing (1210). If so, the computing system repeats the steps of selecting a new product network (1204) and calculating a price-change ratio for each price-optimized solution in the price-optimized solution set (1206). If all product networks in the collection have been processed, the computing system can resume previous processing, which can include resuming processing at step 1104 of method 1100 in FIG. 11.

The present technology can take the form of hardware, software or both hardware and software elements. In some implementations, the technology can be implemented in software, which includes but is not limited to firmware, resident software, microcode, a Field Programmable Gate Array (FPGA), graphics processing unit (GPU), or Application-Specific Integrated Circuit (ASIC). In particular, for real-time or near real-time use, an FPGA or GPU implementation would be desirable.

Furthermore, portions of the present technology can take the form of a computer program product comprising program modules accessible from computer-usable or computer-readable medium storing program code for use by or in connection with one or more computers, processors, or instruction execution system. For the purposes of this description, a computer-usable or computer readable medium can be any apparatus that can contain, store, communicate, propagate, or transport the program for use by or in connection with the instruction execution system, apparatus, or device. The medium can be non-transitory (e.g., an electronic, magnetic, optical, electromagnetic, infrared, or semiconductor system (or apparatus or device)) or transitory (e.g., a propagation medium). Examples of a non-transitory computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. Both processors and program code for implementing each as aspect of the technology can be centralized or distributed (or a combination thereof) as known to those skilled in the art.

The various embodiments described above are provided by way of illustration only and should not be construed to limit the scope of the disclosure. Examples within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection can be properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply not only to a smartphone device but to other devices capable of receiving communications such as a laptop computer. Those skilled in the art will readily recognize various modifications and changes that may be made to the principles described herein without following the example embodiments and applications illustrated and described herein, and without departing from the scope of the disclosure.

What is claimed is:

1. A computer-implemented method comprising:
receiving sales data for at least one product, in at least one store, across a plurality of time periods, wherein the sales data includes at least one time period with zero unit sales; and
generating, via a processor, a demand model based on the sales data as follows:
applying a truncated Poisson distribution to the sales data to generate a derivative vector D and a Hessian matrix H, the truncated Poisson distribution applied to non-zero unit sales in the sales data; and
applying a Newton-Raphson method using the derivative vector D and the Hessian matrix H to generate a coefficient vector V, wherein the coefficient vector V comprises coefficients for elasticity and quantity factors for product-store combinations.

2. The computer-implemented method of claim 1, wherein multiple iterations of applying the truncated Poisson distribution and the Newton-Raphson occur.

3. The computer-implemented method of claim 1, wherein applying the truncated Poisson distribution to the sales data comprises:
for each product-store combination K and time period T computing a forecast F_{KT}; and
computing derivatives for elasticity β and product-store combinations for derivative vector D.

4. The computer-implemented method of claim 1, wherein generating a derivative vector D comprises:
computing a derivative D_{β} for elasticity β and a derivative D_{q}_{_{K}} for each product-store combination K, wherein
$${D}_{β} = {\sum }_{KT} {P}_{KT} {F}_{KT} - {P}_{KT} {U}_{KT} + {P}_{KT} {E}_{KT} , and$$
$${D}_{{q}_{K}} = {\sum }_{T} - {F}_{KT} + {U}_{KT} - {E}_{KT} ,$$
where U_{KT} is units sold for price-store combination K in time period T at the price P_{KT} and E_{KT}=C_{KT}A_{KT}F_{KT}, A_{KT}=e^{-F}^{_{KT}},
$${C}_{KT} = \frac{1}{1 - {A}_{KT}} .$$

5. The computer-implemented method of claim 1, wherein generating the Hessian matrix H comprises:
computing
$${H}_{ββ} = {\sum }_{KT} - {P}_{KT}^{2} {F}_{KT} - {P}_{KT}^{2} {G}_{KT} {F}_{KT} ;$$
computing
$${H}_{β {q}_{K}} = {H}_{{q}_{K} β} = {\sum }_{T} {P}_{KT} {F}_{KT} + {P}_{KT} {G}_{KT} {F}_{KT} ;$$
and
computing
$${H}_{{q}_{K} {q}_{K}} = {\sum }_{T} - {F}_{KT} - {G}_{KT} {F}_{KT} ,$$
where U_{KT} is units sold for price-store combination K in time period T at the price P_{KT}, and G_{KT}=−C_{KT}²A_{KT}²F_{KT}−C_{KT}A_{KT}F_{KT}+C_{KT}A_{KT}, A_{KT}=e^{-F}^{_{KT}}, and
$${C}_{KT} = \frac{1}{1 - {A}_{KT}} .$$

6. The computer-implemented method of claim 1, wherein applying a Newton-Raphson method using the derivative vector D and Hessian matrix H comprises:
computing W=V−H⁻¹D; and
copying W into V when ∥V−W∥>=ε.

7. The computer-implemented method of claim 1, further comprising an initial coefficient vector V comprising coefficients for elasticity β and quantity factors for product-store combinations based on sales history weighted against an assumption that average prices chosen in the sales history are optimal for demand.

8. A manufacture comprising:
a non-transitory computer-readable storage medium; and
a computer executable instruction stored on the non-transitory computer-readable storage medium which, when executed by a computing device, causes the computing device to perform a method comprising:
receiving sales data for at least one product, in at least one store, over a plurality of time periods, wherein the sales data includes at least one time period with zero unit sales; and
generating a demand model based at least on the sales data by iteratively applying:
a truncated Poisson distribution to non-zero unit sales in the sales data to generate a derivative vector D and a Hessian matrix H, and
a Newton-Raphson method using the derivative vector D and the Hessian matrix H to update a coefficient vector V.

9. The manufacture of claim 8, wherein iteratively applying a truncated Poisson distribution and a Newton-Raphson method comprises:
initializing a coefficient vector V;
iteratively updating the coefficient vector V by performing a number of rounds, the number of rounds determined dynamically based on a change in the coefficient vector V, each round comprising:
for each product-store combination K and time period T represented in the sales data with known unit sales, computing a forecast F_{KT};
computing for derivative vector D, a derivative D_{β} for elasticity β and a derivative D_{q}_{_{K}} for each product-store combination K, wherein
$${D}_{β} = {\sum }_{KT} {P}_{KT} {F}_{KT} - {P}_{KT} {U}_{KT} + {P}_{KT} {E}_{KT} , and$$
$${D}_{{q}_{K}} = {\sum }_{T} - {F}_{KT} + {U}_{KT} - {E}_{KT} ,$$
where U_{KT} is units sold for price-store combination K in time period T at the price P_{KT}, and E_{KT}=C_{KT}A_{KT}F_{KT}, A_{KT}=e^{-F}^{_{KT}},
$${C}_{KT} = \frac{1}{1 - {A}_{KT}} ;$$
generating a Hessian matrix H, wherein
$${H}_{ββ} = {\sum }_{KT} - {P}_{KT}^{2} {F}_{KT} - {P}_{KT}^{2} {G}_{KT} {F}_{KT} , \\ {H}_{β {q}_{K}} = {H}_{{q}_{K} β} = {\sum }_{T} {P}_{KT} {F}_{KT} + {P}_{KT} {G}_{KT} {F}_{KT} , and$$
$${H}_{{q}_{K} {q}_{K}} = {\sum }_{T} - {F}_{KT} - {G}_{KT} {F}_{KT} , where$$
$${G}_{KT} = - {C}_{KT}^{2} {A}_{KT}^{2} {F}_{KT} - {C}_{KT} {A}_{KT} {F}_{KT} + {C}_{KT} {A}_{KT} ;$$
computing a new coefficient vector W such that W=V−H⁻¹D; and
computing a difference between W and V, and copying W into V when the difference is greater than a predefined value ε.

10. The manufacture of claim 8, wherein a product-store combination K comprises a collection of products in a price family and a set of stores in a zone.

11. The manufacture of claim 8, wherein the sales data includes inventory data.

12. The manufacture of claim 8, wherein the demand model is used for at least one of price optimization, promotion optimization, markdown optimization, assortment optimization, shelf-space optimization, or retail replenishment.

13. The manufacture of claim 8, wherein the coefficient vector V comprises coefficients for elasticity β and quantity factors for product-store combinations.

14. The manufacture of claim 9, wherein initializing the coefficient vector V comprises reverse engineering coefficients for elasticity β and quantity factors for product-store combinations based on sales history weighted against an assumption that average prices chosen in the sales history are optimal for demand.

15. The manufacture of claim 8, wherein the coefficient vector V comprises coefficients for at least one of price, promotional status, seasonality, holidays, trends, or external factors.

16. A system comprising:
a processor;
a computer readable storage medium storing instructions for controlling the processor to perform steps comprising:
receiving sales data for at least one product, in at least one store, across a plurality of time periods, wherein the sales data includes at least one time period with unknown unit sales; and
generating a demand model based at least on the sales data as follows:
iteratively updating a coefficient vector V by performing a number of rounds, the number of rounds determined dynamically based on a change in the coefficient vector V, each round comprising:
for each product-store combination K and time period T represented in the sales data with non-zero unit sales, applying a truncated Poisson distribution to the non-zero unit sales data to generate a derivative vector D and a Hessian matrix H;
applying a Newton-Raphson method step using the derivative vector D, the Hessian matrix H, and a current coefficient vector V to generate a new coefficient vector W; and
computing a difference between W and V, and copying W into V when the difference is greater than a predefined value epsilon.

17. The system of claim 16, wherein applying a Newton-Raphson method step using the derivative vector D, the Hessian matrix H, and the coefficient vector V comprises:
computing W=V−H⁻¹D.

18. The system of claim 16, wherein the coefficient vector V comprises coefficients for at least one of elasticity, quantity, price, promotional status, seasonality, holidays, trends, or external factors.

19. The system of claim 16, wherein the sales data includes inventory data.

20. The system of claim 16, wherein the demand model is used for at least one of price optimization, promotion optimization, markdown optimization, assortment optimization, shelf-space optimization, or retail replenishment.
